(19) United States
(12) Patent Application Publication
(10) Pub. No.: US 2003/0111776 A1
(43) Pub. Date: Jun. 19, 2003

(54) Hydrolysis-resistant polyamide molding materials for use in gas injection techniques (git)

(76) Inventors: Detlev Joachimi, Krefeld (DE); Roland Sauer, Meinerzhagen (DE)

Correspondence Address: BAYER POLYMERS LLC, 100 BAYER ROAD, PITTSBURGH, PA, 15205, US

(21) Appl. No.: 10/220,796

(22) PCT Filed: Feb. 26, 2001
(86) PCT No.: PCT/EP01/02218

(30) Foreign Application Priority Data
Mar. 10, 2000 (DE) 100 11 452.0

(51) Int. Cl. C08L 1/00

(52) U.S. Cl. 264/572; 524/404

(57) ABSTRACT

The present invention provides a composition of reinforced polyamide (PA) for use in a cooling circuit of an engine. The composition may be processed by a gas injection technique (GIT) into shaped parts having smooth inner surfaces and a good hydrolytic stability against cooling medium such as glycol/water mixtures.

This invention relates to compositions of reinforced PA for use in the coolant circuit, which compositions, when processed using the GAIM process, give rise to mouldings with smooth internal surfaces and good hydrolysis resistance towards coolant (glycol/water mixtures).

Glass-reinforced polyamides, in particular polyamide 66 (PA66), generally reinforced with 30 to 35 wt. % of glass fibre, have been used successfully for injection moulded automotive coolant circuit mouldings for years. Typical applications are the radiator tank and coolant manifold. Such mouldings exhibit adequate resistance to the coolant (in most cases 1:1 ethylene glycol/water mixtures), even at temperatures as high as 130° C.

In addition to the stated applications, it would be desirable for reasons of more favourable production costs and greater reliability in service and durability/corrosion resistance, to replace the metal tubes and rubber hoses in the coolant circuit entirely or in part with thermoplastic tubes. Reinforced PA66 should preferably be used for this application too since, from the standpoint of low-cost production, it at present provides the best compromise between the greatest possible hydrolysis resistance and low material costs. However, when producing tubes by injection moulding, restrictions apply with regard to the possible geometries. Curved tubes cannot be produced using standard injection moulding. While there are indeed specific processes for producing hollow articles with curved internal surfaces (for example fusible core process), these are associated with elevated additional costs.

One low cost alternative could be injection moulding by the GAIT process (GAIT=gas-assisted injection moulding), but this usually results in very rough internal surfaces which, due to their elevated surface area, are more susceptible to attack by the coolant flowing over them. Moreover, there is an increased risk of detachment of glass fibres from the surface, which may then possibly circulate in the coolant circuit and have an abrasive action or form partial deposits or even blockages. While completely dispensing with glass fibres results in smoother internal surfaces, the mechanical properties of the mouldings are then no longer adequate (excessively low modulus of elasticity, excessively low strength) and hydrolysis resistance is greatly reduced. Somewhat better hydrolysis resistance may be achieved by combining glass fibres/glass beads, but the overall level of properties of such compounds is inadequate. Similar considerations apply to compounds which have exclusively mineral reinforcement.

The object of the invention was to provide a material and a process which makes it possible to produce mouldings with a smooth internal surface and good hydrolysis resistance towards coolant (glycol/water mixtures) by the gas-assisted injection moulding process (GAIM process).

It has surprisingly now been found that the combination of glass fibres with mica, in particular with phlogopite mica, in the PA66 compound gives rises to materials which, with conventional addition of additives, are not only suitable for producing tubes by the gas-assisted injection moulding process, but also give rise to finished parts with a relatively smooth internal surface and very good hydrolysis resistance. Particularly good finished part quality with regard to a smooth internal surface and uniform wall thickness distribution has been achieved by the following adaptations to the generally described (in Kunststoffe 1990, 8068, 873-876, Carl Hanser Verlag Munich, 1990) gas-assisted injection moulding (GAIM) process or by selection of the following conditions during GAIM processing:

expulsion process

gas injection via heatable annular slit gas injector with reduced melt in the gas outlet zone

use of a labyrinth seal to provide a seal between the melt and gas injector

gas inlet upstream from the melt gate (relative to main direction of melt flow)

control of wall thickness of finished part by velocity of gas bubble front

use of overflow cavities and associated overflow channels, the volume of which is adjustable.

The present invention provides thermoplastic moulding compositions consisting of 40 to 80 parts by weight of polyamide, preferably PA66, 0 to 45 parts by weight, preferably 5 to 45 parts by weight of glass fibres or other fibrous reinforcing materials, 5 to 45 parts by weight of mica or other lamellar mineral reinforcing materials or fillers and 0 to 5 parts by weight of other additives, such as for example conventional stabilising and processing auxiliaries and dyes, wherein the sum of all the weight percentages must be 100.

Suitable polyamides are known homopolyamides, copolyamides and mixtures of these polyamides. Said polyamides may be partially crystalline and/or amorphous.

Suitable partially crystalline polyamides are polyamide 66, polyamide 6, mixtures and corresponding copolymers prepared from these components. Further polyamides which may be considered are those, the acid component of which consists entirely or in part of terephthalic acid and/or isophthalic acid and/or suberic acid and/or sebacic acid and/or azelaic acid and/or adipic acid and/or cyclohexanedicarboxylic acid, the diamine component of which consists entirely or in part of m- and/or p-xylylenediamine and/or hexamethylenediamine and/or 2,2,4-trimethylhexamethylenediamine and/or 2,2,4-trimethylhexamethylenediamine and/or isophoronediamine and the composition of which is known in principle.

Further polyamides which may be mentioned are those which are produced entirely or in part from lactams having 7 to 12 C atoms, optionally together with one or more of the above-stated starting components.

Polyamide 6,6 is particularly preferred.

Copolymers which are obtained by polycondensation of two or more monomers are also suitable, as are copolymers which are produced with the addition of aminocarboxylic acids, such as -aminocaproic acid, -aminoundecanoic acid or -aminolauric acid or the lactams thereof.

The polyamides preferably exhibit a relative viscosity (measured on a 1 wt. % solution in m-cresol at 25° C.) of 2.7 to 3.5.

The moulding compositions according to the invention may contain additives such as colorants, stabilisers (in particular stabilisers containing copper), lubricants and processing auxiliaries, optionally together with further additives.

The polyamides may additionally contain further fibrous reinforcing materials and/or mineral fillers. Fibrous reinforcing materials other than glass fibres which may be considered are carbon fibres, aramid fibres, mineral fibres and whiskers. Suitable mineral fillers which may be mentioned by way of example are calcium carbonate, dolomite, calcium sulfate, mica, fluorine mica, wollastonite, talcum and kaolin. It is, however, also possible to use other oxides or hydrated oxides of an element selected from the group boron, aluminium, gallium, indium, silicon, tin, titanium, zirconium, zinc, yttrium or iron. The fibrous reinforcing materials and the mineral fillers may be surface treated to improve mechanical properties.

Glass fibres are preferred.

Reinforcing materials which may be considered in addition to or instead of glass fibres are also carbon fibres, aramid fibres, mineral fillers or reinforcing materials and similar materials. These may optionally be provided with surface modifications, for example silanes or glass fibre sizes.

The present invention furthermore provides moulding compositions according to the invention which additionally contain 0.01 to 10 parts by weight, particularly preferably 0.3 to 1.0 parts by weight of antinucleating (crystallisation inhibiting) additives, wherein the sum of all parts by weight must be 100.

The present invention provides moulding compositions in which the lamellar reinforcing material is phlogopite mica.

The present invention also provides the use of the moulding compositions according to the invention for the production of mouldings for the automotive coolant circuit.

The present invention also provides the use of the moulding compositions according to the invention for the production of mouldings for the automotive coolant circuit by means of a gas-assisted injection moulding process.

The present invention also provides the use of the moulding compositions according to the invention for the production of mouldings for the automotive coolant circuit by means of a gas-assisted injection moulding process, wherein the melt expulsion method is preferably used.

The present invention also provides the use of the moulding compositions according to the invention for the production of mouldings for the automotive coolant circuit by means of a gas-assisted injection moulding process, wherein the standard GAIM process (melt inflation method) or the melt expulsion method or a combination of inflation and expulsion methods is preferably used.

The present invention also provides a process for the production of mouldings using the GAIM process, characterised in that the following are combined

expulsion process

gas injection via heatable annular slit gas injector with reduced melt in the gas outlet zone

use of a labyrinth seal to provide a seal between the melt and gas injector

gas inlet upstream from the melt gate (relative to main direction of melt flow)

control of wall thickness of finished part by velocity of gas bubble front

use of overflow cavities and associated overflow channels, the volume of which is adjustable.

The present invention also provides mouldings produced according to one or more of the preceding claims.

### EXAMPLE

GAIM Processing

S-shaped automotive coolant tubes (total length 250 mm, external diameter 19 mm, average wall thickness 3 mm) with a connector were produced from the various materials listed in Example 1 using the gas-assisted injection moulding process (expulsion method). The injection moulding machine used was an Engel ES 700/150. Gas was injected via an annular slit gas injector with adjustable annular slit width and integral labyrinth seal. Melt temperatures were adjusted, in accordance with the moulding composition standard relevant to the materials, to between 280 and 310° C., while the mould temperature was approx. 80° C. for all tests. Gas was injected at pressures of 100 to 300 bar, in most cases at approx. 250 bar. The pressure gas was nitrogen, which was apportioned by a Battenfeld Airmold unit.

Production of Compounds

The polyamide compounds used in Examples 1 to 4 and 11 and Comparative Example 12 and 13 were produced by compounding polyamide 66 or polyamide 6 with the reinforcing materials and additives listed in Table 1 in Werner & Pfleiderer ZSK 32 twin screw extruders in the conventional manner (melting of the polymer, optionally as a mixture with the additives, addition of the reinforcing materials to the polyamide melt, drawing off the strand through a water bath and subsequent pelletisation). Before further processing, the resultant pellets were dried to a residual moisture content of <0.12% at 70° C. under a vacuum.

In Examples 5 to 10, mineral-filled compounds were physically mixed in pellet form with glass fibre-reinforced PA66 (Durethan AKV 30 HR H2.0 9005/0, commercial product of Bayer AG) in various ratios and further processed in this form (as a “dry blend”).

Determination of Mechanical Properties When Freshly Injection Moulded and After Immersion in Coolant

The values for mechanical properties stated in the Table were determined on standard 80×10×4 mm test specimens, which were produced in accordance with the relevant moulding composition standards. Izod impact strength was determined to ISO 180 1C, while flexural modulus was determined in accordance with the ISO 178 flexural test.

The influence of coolant on mechanical properties was investigated by immersing unnotched standard 80×10×4 mm test specimens in an autoclave at 130° C. filled with coolant (1 L ethylene glycol/1 L water). A pressure of approx. 2 bar is established in this manner. After 42 days' immersion under these conditions, after cooling to room temperature, the test specimens were removed, rinsed with water, dried and heat-sealed in PE film. After 4 hours' equalisation, testing was performed.

| | | | Glass | Glass | Phlogopite | | |
|---|---|---|---|---|---|---|---|
| | PA6 | PA66 | microbeads¹⁾ | fibres² | mica³⁾ | Kaolin⁵⁾ | Talc⁶⁾ |
| Composition⁴⁾ | [%] | [%] | [%] | [%] | [%] | [% ] | [%] |
| Comparative Example 1 | | 67.6 | 20 | 10 | — | | |
| Example 2 | | 67.6 | | 10 | 20 | | |
| Example 3 | | 57.6 | | 10 | 30 | | |
| Example 4 | | 57.6 | | | 40 | | |
| Example 5⁷⁾ | 43.2 | 22.6 | | 10 | | 20 | |
| Example 6⁸⁾ | 48.6 | 16.9 | | 7.5 | | 22.5 | |
| Example 7⁹⁾ | 27.7 | 38.2 | | 12.3 | | 17.7 | |
| Example 8¹⁰ | | 63.7 | | 10 | | | 20 |
| Example 9¹¹⁾ | | 59.4 | | 7.5 | | | 22.5 |
| Example 10¹²⁾ | | 61.1 | | 12.3 | | | 17.7 |
| Example 11 | | 64.8 | | 10 | | 20 | |
| Comparative Example 12 | | 99.5 | | | | | |
| Comparative Example 13 | | 67.6 | | 30 | | | |

1) CP 3000, commercial product of Potters Ballotini

2) Vetrotex P 955, commercial product of Vetrotex

3) e.g. Kemira Mica 100S of Kemira or Mica 5100 S, commercial product of Polar Minerals

4) All compounds contain copper iodide (300-400 ppm) mixed with potassium bromide (800 to 1000 ppm) as heat stabiliser, approx. 0.2% demoulding auxiliary (amide wax or montan ester wax), 0.2 to 0.8% blackening agent (carbon black, nigrosine) and approx. 200 ppm microtalc as nucleating agent

5) Polarite 102 A from Imerys

6) Naintsch A 60, commercial product of Talc de Luzenac

7) Mixture of 33.3% PA66 GF30 (Durethan AKV 30 HR H2.0 9005/0, commercial product of Bayer AG) with 66.7% Durethan BM 230 H2.0 9005/0 (commercial product of Bayer AG)

8) 25% Durethan AKV 30HR H2.0 9005/0 (commercial product of Bayer AG) 75% Durethan BM 230 H2.0 9005/0 (commercial product of Bayer AG)

9) 41% Durethan AKV 30 HR H2.0 9005/0 (commercial product of Bayer AG) 59% Durethan BM 230 H2.0 9005/0 (commercial product of Bayer AG)

10) 33.3% Durethan AKV 30 HR H2.0 9005/0 (commercial product of Bayer AG) 66.7% Durethan AM 140 H2.0 9005/0 (commercial product of Bayer AG)

11) 25% Durethan AKV 30 HR H2.0 9005/0 (commercial product of Bayer AG) 75% Durethan AM 140 H2.0 9005/0 (commercial product of Bayer AG)

12) 41% Durethan AKV 30 HR H2.0 9005/0 (commercial product of Bayer AG) 59% Durethan AM 140 H2.0 9005/0 (commercial product of Bayer AG)

| | | Ra | | | | | |
|---|---|---|---|---|---|---|---|
| | | Average | Wt | | | | |
| | | roughness | Maximum | Izod impact | Izod impact | | Flexural |
| | | value of | wave depth | strength, | strength after | Flexural | modulus after |
| | Roughness of | internal | of internal | freshly | 42 days^{\} | modulus, freshly | 42 days′ |
| | internal | surface | surface | injection | imersion | injection | immersion in |
| | surface of | of tube | of tube | moulded | in coolant | moulded | coolant |
| | tube | [μm] | [μm] | [kJ/m²] | [kJ/m²] | [MPa] | [MPa] |
| Comparative Example | smooth | | | 29 | 6 | 5800 | 1230 |
| 1 | | | | | | | |
| Example 2 | smooth-rough | 6.9 | 80.3 | 37 | 10 | 8120 | 2200 |
| Example 3 | smooth-rough | 9.6 | 130.0 | 28 | 7 | 10900 | 2070 |
| Example 4 | smooth | 1.3 | 18.3 | 17 | 9 | 11400 | 2910 |
| Example 5⁷⁾ | smooth | 5.6 | 72.1 | 44 | | 6100 | |
| Example 6⁸⁾ | smooth | 3.7 | 49.7 | 47 | | 5730 | |
| Example 7⁹⁾ | smooth-rough | 4.4 | 76.9 | 45 | | 6160 | |
| Example 8¹⁰⁾ | smooth | 5.4 | 86.9 | 29 | 9 | 9540 | 2950 |
| Example 9¹¹⁾ | smooth | 6.4 | 67.1 | 26 | 8 | 9620 | 2800 |
| Example 10¹²⁾ | smooth | 4.6 | 57.6 | 35 | 10 | 9350 | 3030 |
| Example 11 | smooth | | | 37 | 6 | 5640 | 1430 |
| Comparative Example | smooth | <1 | <10 | 140 | <1 | 3200 | <100 |
| 12 | | | | | | | |
| Comparative Example | very rough | 11.5 | 165 | 65 | 8 | 8590 | 3100 |
| 13 | | | | | | | |

1. Thermoplastic moulding compositions consisting of 40 to 80 parts by weight of polyamide, 0 to 45 parts by weight, preferably 5 to 45 parts by weight of glass fibres or other fibrous reinforcing materials, 5 to 45 parts by weight of mica or other lamellar mineral reinforcing materials or fillers and 0 to 5 parts by weight of additives, wherein the sum of all the weight percentages must be 100.

2. Moulding compositions according to claim 1, which additionally contain 0.01 to 10 parts by weight of antinucleating additives, wherein the sum of all the weight percentages must be 100.

3. Moulding compositions according to claim 1 and/or 2, in which the lamellar reinforcing material is phlogopite mica.

4. Use of the moulding compositions according to one or more of the preceding claims for the production of mouldings for the automotive coolant circuit.

5. Use of the moulding compositions according to one or more of the preceding claims for the production of mouldings for the automotive coolant circuit by means of a gas-assisted injection moulding process.

6. Use of the moulding compositions according to one or more of the preceding claims for the production of mouldings for the automotive coolant circuit by means of a gas-assisted injection moulding process, wherein the standard GAIM process (melt inflation method) or the melt expulsion method or a combination of inflation and expulsion methods is used.

7. A process for the production of mouldings using the GAIM process, characterised in that the following are combined
expulsion process
gas injection via heatable annular slit gas injector with reduced melt in the gas outlet zone
use of a labyrinth seal to provide a seal between the melt and gas injector
gas inlet upstream from the melt gate (relative to main direction of melt flow)
control of wall thickness of finished part by velocity of gas bubble front
use of overflow cavities and associated overflow channels, the volume of which is adjustable.

8. Mouldings produced according to one or more of the preceding claims.
